(19) United States
(12) Patent Application Publication
(10) Pub. No.: US 2005/0044823 A1
(43) Pub. Date: Mar. 3, 2005

(54) Light up horse equipment

(76) Inventor: Jamie L. Collins, Pittsburgh, PA (US)

Correspondence Address: JAMES RAY & ASSOCIATES, 2640 PITCAIRN ROAD, MONROEVILLE, PA, 15146, US

(21) Appl. No.: 10/902,238

(22) Filed: Jul. 29, 2004

Related U.S. Application Data
(60) Provisional application No. 60/497,989, filed on Aug. 26, 2003.

(51) Int. Cl. B68B 1/04

(52) U.S. Cl. 54/6.1

(57) ABSTRACT

An illuminated tack apparatus is disposed on a horse for night time usage. Such illuminated tack apparatus comprises at least one strap like member having a predetermined length and a predetermined shape formed from a flexible material. There is a predetermined plurality of illumination means disposed along the predetermined length of the at least one strap like member. A power source is disposed at a predetermined location along the predetermined length of the strap like member and wiring is connected to the power source and to each of the predetermined plurality of illumination means. Further, there is a switch means connected to the power source for at least one of completing and interrupting power to the plurality of illumination means.

### CROSS REFERENCE TO RELATED APPLICATIONS

This application is closely related to and claims benefits from U.S. Provisional Application Ser. No. 60/497,989, filed Aug. 26, 2003.

### FIELD OF THE INVENTION

The present invention relates, in general, to horse equipment, and, more particularly, the present invention relates to horse equipment such as bridles, breast collars, conchos and sheaths in which the horse equipment is equipped with lights to provide night time visibility.

### BACKGROUND OF THE INVENTION

Horse back riding is an enjoyable recreation for many people. This riding can be trail riding, horse showings and other such equine endeavors. Horse riding has become a popular sport among people. With riding, such as endurance riding, riders tend to be on the horse for extended periods of time. More and more people are enjoying an evening ride and in many cases this can lead into night riding.

Night riding can be dangerous. This is especially true along roads which are also used by vehicles. In the case of night riding it is important that there is something on the horse which will enable other people to see the horse and rider. And equally important that the horse and rider be seen quickly. Reflectors have been used as a means of providing visibility; however, reflectors are generally visible only when headlights or other type of lights shine on them and reflect the light off of them. Further, reflectors may not be visible, for example, to the driver of an automobile until the driver is right upon the horse and rider. This can present a dangerous situation.

### SUMMARY OF THE INVENTION

The present invention provides an illuminated tack apparatus disposed on a horse for night time usage. Such illuminated tack apparatus comprises at least one strap like member having a predetermined length and a predetermined shape formed from a flexible material. There is a predetermined plurality of illumination means disposed along the predetermined length of the at least one strap like member. A power source is disposed at a predetermined location along the predetermined length of the strap like member and wiring is connected to the power source and to each of the predetermined plurality of illumination means. Further, there is a switch means connected to the power source for at least one of completing and interrupting power to the plurality of illumination means.

### OBJECTS OF THE INVENTION

It is, therefore, one of the primary objects of the present invention to provide horse equipment in which lights have been mounted to enable the equipment to emit light so as to be visible at night.

Another object of the present invention is to provide light up horse equipment which is run on batteries.

It is still another object of the present invention to provide lights on the breast collar of a horse.

Still another object of the present invention is to provide light up horse equipment which is inexpensive to manufacture.

Yet, another object of the present invention is to provide light up horse equipment which can be seen from a far distance.

Another object of the present invention is to provide light up horse equipment which has a switch for either energizing or deenergizing the apparatus.

In addition to the numerous objects and advantages of the present invention which have been described with some degree of particularity above, it should be both noted and understood that a number of other important objects and advantages of the invention will become more readily apparent to those persons who are skilled in the relevant art from the following more detailed description of the invention, particularly, when such detailed description is taken in conjunction with the appended claims.

### BRIEF DESCRIPTION OF THE DRAWINGS

FIG. 1 is a perspective view of a bridle according to an embodiment of the invention showing the front sheath.

FIG. 2 is a back view of the bridle shown in FIG. 1 showing the wiring and LED's attaching to a battery.

FIG. 3 is a back portion of the leather sheath of the bridle shown in FIG. 1.

FIG. 4 is a perspective view of a completed bridle of the light up horse equipment.

FIG. 5 is a side view of the concho and hoop portion of the sheath of FIG. 1 with the battery case included.

FIG. 6 is a front view of a breast collar showing the front sheath.

FIG. 7 is a front view of the breast collar showing the front sheath shown in FIG. 6 with the wiring, LED's and battery case attached.

FIG. 8 is a view of the back sheath of the breast collar shown in FIG. 7.

FIG. 9 is a front view of a complete breast collar.

FIG. 10 is a side view of the complete breast collar shown in FIG. 8.

FIG. 11 is a side view of the concho and ring attachment to the sheath of FIG. 6 with the battery case included.

FIG. 12 is an enlarged cutaway view of the power source of the apparatus with the switch means disposed thereon.

### BRIEF DESCRIPTION OF THE PRESENTLY PREFERRED AND VARIOUS ALTERNATE EMBODIMENTS OF THE PRESENT INVENTION

Prior to proceeding to the more detailed description of the present invention, it should be noted that for the sake of clarity in understanding the invention, identical components with identical functions have been designated with identical reference numerals throughout the drawing Figures.

The present invention provides an illuminated tack apparatus, generally designated 10, for use on a horse during night time usage. Such illuminated tack apparatus 10 comprises at least one strap like member, hereinafter referred to as a sheath, having a predetermined length and a predetermined shape formed from a flexible material. There is a predetermined plurality of illumination means disposed along the predetermined length of the at least one strap like member (sheath). A power means is disposed at a predetermined location at least one of along the predetermined length of the sheath and adjacent a preselected end of a sheath. Wiring is connected to the power means and to each of the predetermined plurality of illumination means. Further, there is a switch means connected to such wiring for at least one of completing and interrupting power from the power means to the plurality of illumination means.

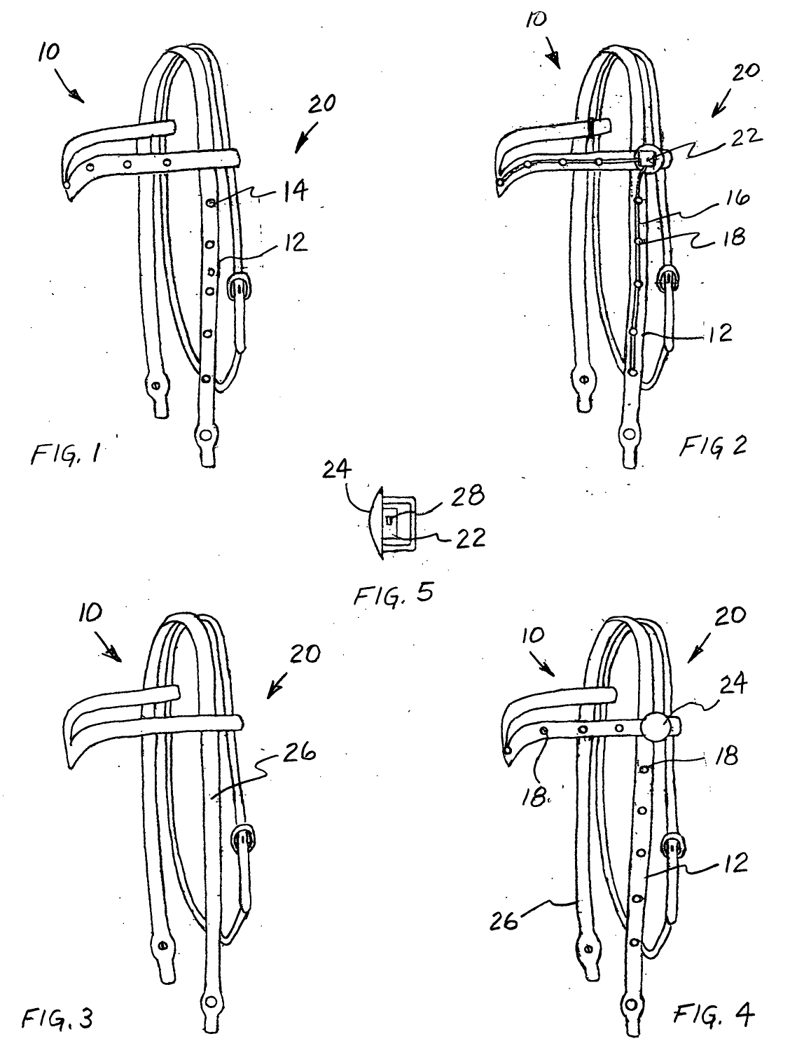

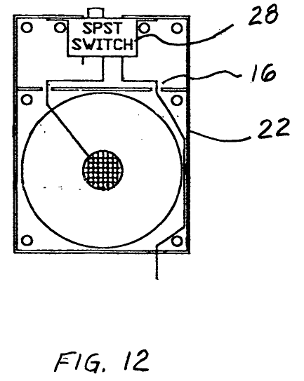

Illustrated in the drawing Figures is an illuminated tack apparatus 10, according to the embodiments of the present invention. Illustrated in FIGS. 1-4 is a bridle, generally designated 20. The bridle 20, according to the present invention has a front sheath 12. Such front sheath 12 has a plurality of holes 14 disposed therein. Such bridle 20 further includes wiring 16 that runs through the front sheath 12 and a plurality of illumination means 18 that are connected to the wiring 16. The illumination means 18 are disposed in each of the holes 14 in the front sheath 12. It is presently preferred that such illumination means 18 are LED's. The apparatus 10 also includes a power means 22. It is presently preferred that such power means 22 is a battery 22. As seen in FIG. 5 such battery 22 is disposed in a concho 24. Such battery 22 is controlled by a switch 28 disposed on such wiring 16. Such switch 28 is for either interrupting or completing power from the power means 22 to the plurality of illumination means 18 disposed on the front sheath 12. Illustrated in FIG. 12 is an enlarged cutaway view of the power means 22 with the switch 28 which controls the battery 22 connected to the wiring 16.

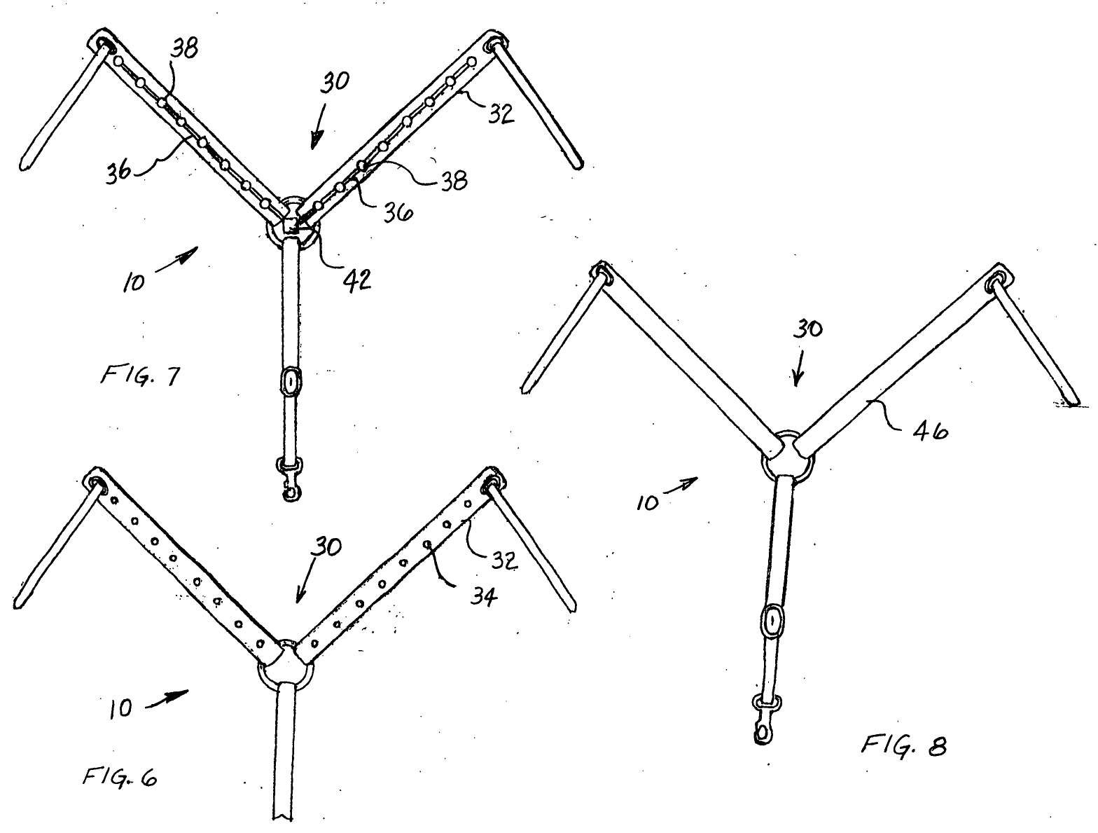

Illustrated in FIG. 3 such bridle 20 also has a back sheath 26. Such front sheath 12 and back sheath 26 are made of flexible material. Such flexible material is selected from a group consisting of vinyl, nylon, rubber and leather. It is presently preferred that such flexible material is leather. Such front sheath 12 with the wiring 16 and illumination means 18 is attached to the back sheath 24 by one of stitching, adhesive, snaps and Velcro (hook and loop fasteners). It is presently preferred that such front sheath 12 be attached to the back sheath 24 by means of stitching. FIG. 4 illustrates the complete bridle 20 with the illumination means 18 attached to the front sheath 12. Illustrated in FIG. 12 is a cutaway view of the power means Illustrated in FIGS. 6-11 is the apparatus 10 according to another embodiment of the invention. This embodiment includes a breast collar, generally designated 30. The breast collar 30 according to the present invention has a front sheath 32. Such front sheath 32 has a plurality of holes 34 disposed therein. Such breast collar 30 further includes wiring 36 that runs through the front sheath 32 and a plurality of illumination means 38 that are connected to the wiring 36 as is illustrated in FIG. 7. The illumination means 38 are disposed in each of the holes 34 in the front sheath 32. It is presently preferred that such illumination means 38 are LED's. The apparatus 10 also includes a power means 42. It is presently preferred that such power means 42 is a battery 42. The battery is disposed on concho 44. Power from the battery 42 is controlled by a switch 48 that is disposed on the wiring. For ease in the use of the apparatus, it is preferred that such switch 48 be disposed on the battery case as is shown in FIG. 11. Such switch 48 is for either interrupting or completing power from the power source 42 to the plurality of illumination means 38.

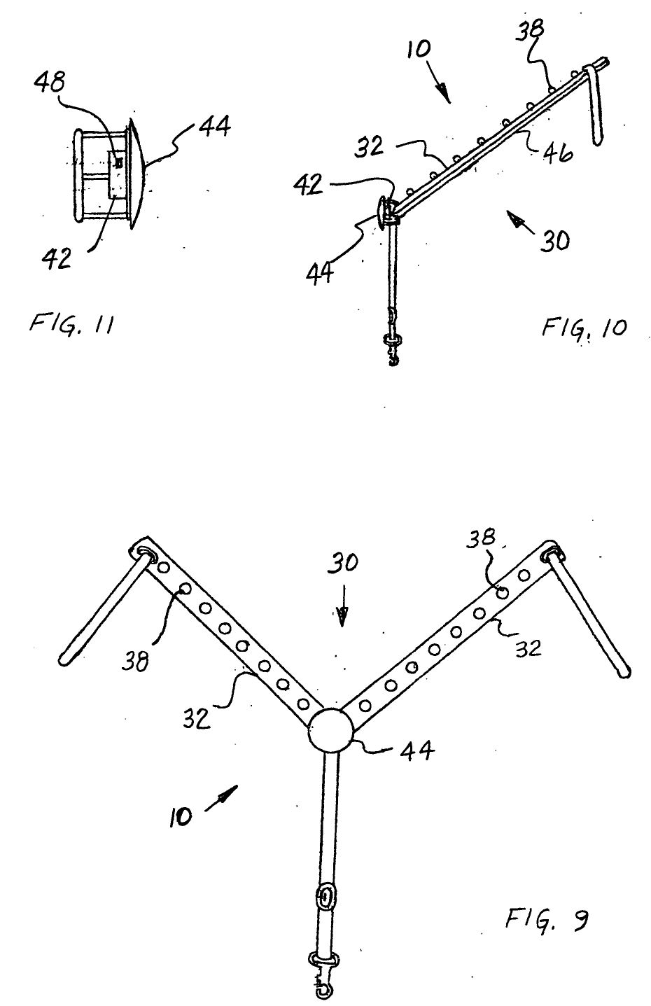

The breast collar 30 also has a back sheath 46 as is seen in FIG. 8. Such front sheath 32 and back sheath 46 are made of flexible material. Such flexible material is selected from a group consisting of vinyl, nylon, rubber and leather. It is presently preferred that such flexible material is leather. Such front sheath 32 with the wiring 36 and illumination means 38 is attached to the back sheath 44 by means of at least one of stitching, adhesive, snaps and Velcro (hook and loop fasteners). It is presently preferred that such front sheath 32 be attached to the back sheath 46 by means of stitching. Illustrated in FIGS. 9 and 10 is a complete breast collar 30 with the front sheath 32, back sheath 46 and the illumination means 38 attached. Stitching the front sheath to the back sheath, not only can be used to provide an attractive edging to the tack apparatus 10, but also protects the wiring and Led's that are essentially disposed on the underside (although the LED's protrude through the holes) of the front sheath in both embodiments.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

1. An illuminated tack apparatus for use on a horse during at least one of night time riding and night time driving, said illuminated tack apparatus comprising:
(a) at least one strap like member having a predetermined length and a predetermined shape formed from a flexible material;
(b) a predetermined plurality of illumination means disposed along said predetermined length of said at least one strap like member;
(c) a power source disposed at a predetermined location at least one of along said predetermined length and adjacent a preselected end of said at least one strap like member;
(d) wiring connected to said power source and to each of said predetermined plurality of illumination means; and
(e) a switch means connected to said wiring for at least one of completing and interrupting power from said power source to said plurality of illumination means.

2. The illuminated tack apparatus, according to claim 1, wherein said power source is a battery.

3. The illuminated tack apparatus, according to claim 1, wherein said flexible material used to form said at least one strap like member is selected from the group consisting of vinyl, nylon, rubber and leather.

4. The illuminated tack apparatus, according to claim 3, wherein said flexible material used to form said at least one strap like member is leather.

5. The illuminated tack apparatus, according to claim 1, wherein said at least one strap like member is engageable with and forms a part of a bridle.

6. The illuminated tack apparatus, according to claim 1, wherein said at least one strap like member is engageable with and forms a part of a breast collar.

7. The illuminated tack apparatus, according to claim 5, wherein said at least one strap like member includes a front sheath and a back sheath.

8. The illuminated tack apparatus, according to claim 7, wherein said wiring is disposed along said front sheath.

9. The illuminated tack apparatus, according to claim 8, wherein said front sheath has a plurality of holes disposed therein.

10. The illuminated tack apparatus, according to claim 9, wherein said illumination means are disposed in said holes in said front sheath.

11. The illuminated tack apparatus, according to claim 10, wherein said front sheath with said illumination means disposed therein and said wiring attached thereto is attached to said back sheath.

12. The illuminated tack apparatus, according to claim 11, wherein said front sheath is attached to said back sheath by at least one of stitching, adhesive, snaps, and hook and loop fasteners.

13. The illuminated tack apparatus, according to claim 12, wherein said front sheath is attached to said back sheath by stitching.

14. The illuminated tack apparatus, according to claim 6, wherein said at least one strap like member includes a front sheath and a back sheath.

15. The illuminated tack apparatus, according to claim 14, wherein said wiring is disposed along said front sheath.

16. The illuminated tack apparatus, according to claim 15, wherein said front sheath has a plurality of holes disposed therein.

17. The illuminated tack apparatus, according to claim 16, wherein said front sheath with said illumination means disposed therein and said wiring attached thereto is attached to said back sheath.

18. The illuminated tack apparatus, according to claim 17, wherein said front sheath is attached to said back sheath by at least one of stitching, adhesive, snaps, and hook and loop fasteners.

19. The illuminated tack apparatus, according to claim 18, wherein said front sheath is attached to said back sheath by stitching.

20. The illuminated tack apparatus, according to claim 1, wherein said power means is disposed in a Concho that is engageable with said at least one strap like member.
